(19) United States
(12) Patent Application Publication
(10) Pub. No.: US 2005/0225245 A1
(43) Pub. Date: Oct. 13, 2005

(54) Plasma display panel

(76) Inventors: Seung-Beom Seo, Suwon-si (KR); Won-Ju Yi, Suwon-si (KR); Seok-Gyun Woo, Suwon-si (KR); Kyoung-Doo Kang, Suwon-si (KR); Seung-Uk Kwon, Suwon-si (KR)

Correspondence Address: Robert E. Bushnell, Suite 300, 1522 K Street, N.W., Washington, DC, 20005-1202, US

(21) Appl. No.: 11/102,836

(22) Filed: Apr. 11, 2005

(30) Foreign Application Priority Data
Apr. 9, 2004 (KR) 10-2004-0024483
May 3, 2004 (KR) 10-2004-0030930
May 3, 2004 (KR) 10-2004-0030931

(51) Int. Cl. H01J 17/49

(52) U.S. Cl. 313/582

(57) ABSTRACT

A plasma display panel (PDP) having improved luminous efficiency may be constructed with an upper substrate, a lower substrate disposed parallel to the upper substrate, and a plurality of upper barrier ribs formed of a dielectric disposed between the upper substrate and the lower substrate. The upper barrier ribs, together with the upper substrate and the lower substrate, define discharge cells. A plurality of upper discharge electrodes are disposed to surround the discharge cell are embedded in the upper barrier ribs. A plurality of lower discharge electrodes that are spaced-apart from the upper discharge electrodes are embedded in the upper barrier ribs to surround the discharge cell. A plurality of lower barrier ribs are disposed between the upper barrier ribs and the lower substrate. A plurality of central barrier ribs may be positioned inside the discharge cells, a plurality of fluorescent layers are formed between side surfaces of the lower barrier ribs and side surfaces of the central barrier ribs, and a discharge gas is used to fill the discharge cells.

### CLAIM OF PRIORITY

This application makes reference to, incorporates the same herein, and claims all benefits accruing under 35 U.S.C. §119 from three applications all of which are entitled PLASMA DISPLAY PANEL and respectively filed in the Korean Intellectual Property Office on the 9^{th} of Apr. 2004, the 3^{rd} of May 2004, and the 3^{rd} of May 2004, and there duly assigned Serial Nos. 10-2004-0024483, 10-2004-0030930, and 10-2004-0030931, respectively.

### BACKGROUND OF THE INVENTION

1. Technical Field

The present invention relates to a plasma display panel (PDP), and more particularly, to plasma display panels exhibiting improved light emitting efficiency.

2. Related Art

A plasma display panel (PDP) similar to the PDP disclosed in Japanese Patent Laid-Open publication 1998-172442 includes a lower substrate, address electrodes disposed parallel to each other on an upper surface of the lower substrate, a lower dielectric layer that covers the address electrodes, barrier ribs formed on the lower dielectric layer, a fluorescent layer formed on an upper surface of the lower dielectric layer and sidewalls of the barrier ribs, an upper substrate disposed parallel to the lower substrate, sustaining discharge electrode pairs disposed on a lower surface of the upper substrate, an upper dielectric layer that covers the sustaining discharge electrode pairs, and a protection layer that covers the upper dielectric layer. The sustaining discharge electrode pairs includes an X electrode and Y electrode, and the X electrode includes a bus electrode and a transparent electrode and the Y electrode includes a bus electrode and a transparent electrode.

In the PDP, a sub-pixel is defined by one sustaining discharge electrode pair and two adjacent barrier ribs. A sub-pixel for emitting light is selected by an address discharge between the address electrodes and the Y electrode, and the sub-pixel emits light by a sustaining discharge occurring between the X electrode and the Y electrode of the selected sub-pixel. More specifically, a discharge gas which fills the sub-pixel emits ultraviolet rays during the sustaining discharge and the ultraviolet rays excite the fluorescent layer to emit visible light. Light emitted from the fluorescent layer displays an image on the PDP.

To increase the light emitting efficiency of a PDP, the space for generating a sustaining discharge must be large enough to excite a discharge gas, the surface area of a fluorescent layer must be wide, and structural configurations that hinder the emission of visible light from the fluorescent layer must be minimized.

In the PDP, however, the space for generating a discharge is small because the sustaining discharge occurs only in a space between the X electrode and Y electrode closed by the protection layer, the surface area of the fluorescent layer is not especially wide, and visible light that passes through the upper substrate is reduced to approximately 60% of the light emitted from the fluorescent layer since the visible light emitted from the fluorescent layer is absorbed and reflected by the protection layer, the upper dielectric layer, the transparent electrodes, and the bus electrodes.

To increase the surface area of the fluorescent layer, a central barrier rib may be formed in the sub-pixel, and the fluorescent layer may also be formed on side surfaces of the central barrier rib. We have discovered that this structure is not desirable, however, because the central barrier rib may interrupt the sustaining discharge between the X electrode and the Y electrode.

### SUMMARY OF THE INVENTION

It is therefore, one object of the present invention to provide a plasma display panel (PDP) having improved light emission efficiency.

According to an aspect of the present invention, a plasma display panel (PDP) may be constructed with an upper substrate; a lower substrate disposed parallel to the upper substrate; a plurality of upper barrier ribs formed of a layer of a dielectric material disposed between the upper substrate and the lower substrate, with the upper barrier ribs defining discharge cells together with the upper substrate and the lower substrate; a plurality of upper discharge electrodes disposed in the upper barrier ribs to surround the discharge cell; a plurality of lower discharge electrodes separated from the upper discharge electrodes and disposed in the upper barrier ribs to surround the discharge cell; a plurality of lower barrier ribs disposed between the upper barrier ribs and the lower substrate; a plurality of central barrier ribs disposed in the discharge cells; a plurality of fluorescent layers formed between side surfaces of the lower barrier ribs and side surfaces of the central barrier ribs; and a discharge gas filling the discharge cells.

According to another aspect of the present invention, a PDP may be constructed with an upper substrate; a lower substrate disposed parallel to the upper substrate; a plurality of upper barrier ribs formed of a dielectric material disposed between the upper substrate and the lower substrate, the upper barrier ribs defining discharge cells together with the upper substrate and the lower substrate; a plurality of upper discharge electrodes disposed in the upper barrier ribs to surround the discharge cell; a plurality of lower discharge electrodes separated from the upper discharge electrodes and disposed in the upper barrier ribs to surround the discharge cell; a plurality of lower barrier ribs disposed between the upper barrier ribs and the lower substrate; a fluorescent layer on which a plurality of protrusions for increasing the surface area are formed disposed in the discharge cell; and a discharge gas filling the discharge cell.

According to one aspect of the present invention, there is provided a PDP having improved light emission efficiency is provided.

Also, in another aspect there is provided a PDP that facilitates the exhaustion of impure gases and the insertion of a discharge gas.

In yet another aspect, there is provided a PDP having improved light emission efficiency as a result of a reduction of the address voltage.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cutaway exploded oblique view of a plasma display panel (PDP);

FIG. 2 is a cross-sectional view taken along sectional line II-II of FIG. 1, modified to illustrate placement of a central barrier rib;

FIG. 3 is a cutaway exploded oblique view of a PDP constructed as a first embodiment of the present invention;

FIG. 4A is a partial cross-sectional view taken along sectional line IV-IV of FIG. 3;

FIG. 4B is a detailed view extracted from the cross-sectional view in FIG. 4A;

FIG. 5 is a partial oblique view illustrating the structure of electrodes in the PDP of FIG. 3;

FIG. 6 is a cross-sectional view of a first modified version of the first embodiment;

FIG. 7 is a partial oblique view illustrating the structure of electrodes in the first modified version of the first embodiment;

FIG. 8 is a cross-sectional view of a second modified version of the first embodiment;

FIG. 9 is a partial oblique view illustrating the structure of electrodes in the second modified version of the first embodiment;

FIG. 10 is a cutaway exploded oblique view of a PDP according to a second embodiment of the present invention;

FIG. 11 is a partial cross-sectional view taken along sectional line XI-XI of FIG. 10;

FIG. 12 is a cutaway exploded oblique view of a PDP according to a third embodiment of the present invention;

FIG. 13 is a partial cross-sectional view taken along sectional line XIII-XIII of FIG. 12;

FIG. 14 is a partial oblique view illustrating the structure of electrodes in the PDP of FIG. 12;

FIG. 15 is a cutaway exploded oblique view of a PDP according to a modified version of the third embodiment of the present invention;

FIG.16A is a partial cross-sectional view taken along sectional line XVI-XVI of FIG. 15;

FIG. 16B is a detailed view extracted from the cross-sectional view of FIG. 16A;

FIG. 17 is a cutaway exploded oblique view of a PDP according to a fourth embodiment of the present invention;

FIG. 18 is a partial cross-sectional view taken along sectional line XVIII-XVIII of FIG. 17;

FIG. 19 is a partial oblique view illustrating the structure of electrodes in the PDP of FIG. 17;

FIG. 20 is a cutaway exploded oblique view of a PDP according to a fifth embodiment of the present invention;

FIG. 21 is a partial cross-sectional view taken along sectional line XXI-XXI of FIG. 20;

FIG. 22 is a cutaway exploded oblique view of a PDP according to a sixth embodiment of the present invention; and

FIG. 23 is a partial cross-sectional view taken along sectional line XXIII-XXIII of FIG. 22.

### DETAILED DESCRIPTION OF THE INVENTION

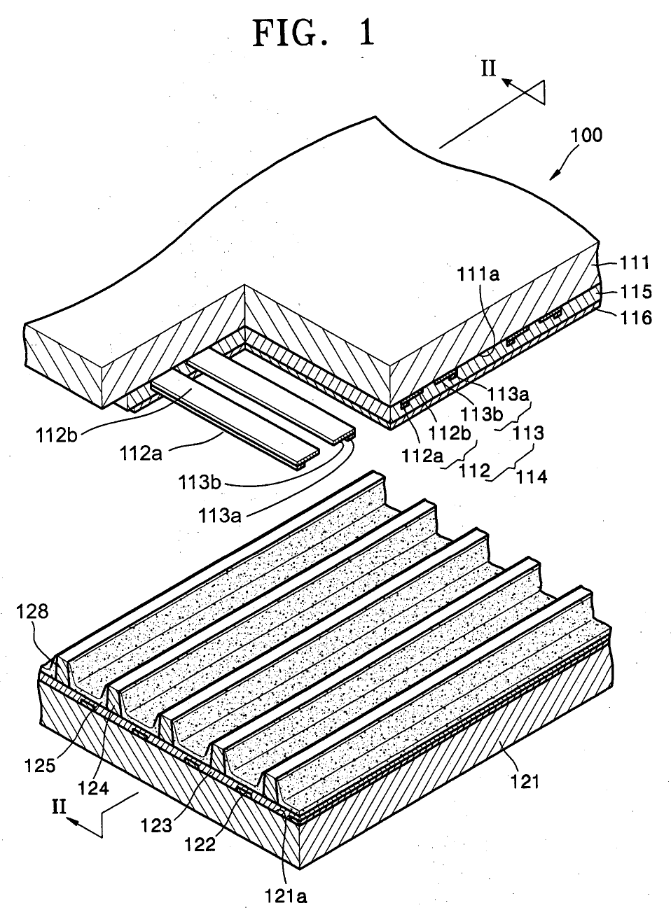

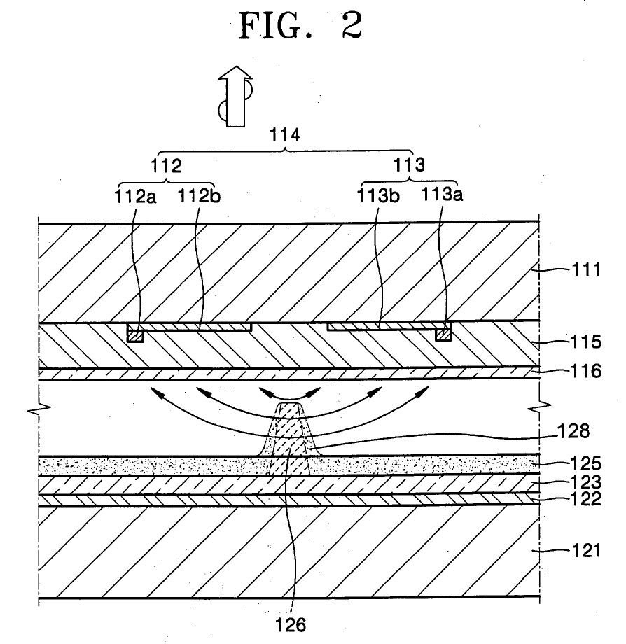

FIG. 1 is a cutaway exploded oblique view of a plasma display panel (PDP), while FIG. 2 is a cross-sectional view taken along sectional line II-II of FIG. 1.

Referring to FIG. 1, PDP 100 includes a lower substrate 121, address electrodes 122 disposed parallel to each other on an upper surface 121a of lower substrate 121, a lower dielectric layer 123 that covers address electrodes 122, barrier ribs 124 formed on lower dielectric layer 123, a fluorescent layer 125 formed on an upper surface of lower dielectric layer 123 and sidewalls 128 of barrier ribs 124, an upper substrate 111 disposed parallel to lower substrate 121, sustaining discharge electrode pairs 114 disposed on a lower surface of the upper substrate 111, an upper dielectric layer 115 that covers sustaining discharge electrode pairs 114, and a protection layer 116 that covers dielectric layer 115. Sustaining discharge electrode pairs 114 include an X electrode 112 and Y electrode 113, and X electrode 112 includes a bus electrode 112a and a transparent electrode 112b and Y electrode 113 includes a bus electrodes 113a and a transparent electrode 113b.

In PDP 100, a sub-pixel is defined by one sustaining discharge electrode pair 114 and two adjacent barrier ribs 124. A sub-pixel for emitting light is selected by an address discharge between address electrodes 122 and Y electrode 113, and the sub-pixel emits light by a sustaining discharge occurring between X electrode 112 and Y electrode 113 of the selected sub-pixel. More specifically, a discharge gas which fills the sub-pixel emits ultraviolet rays in response to the sustaining discharge; the ultraviolet rays then excite fluorescent layer 125 to emit visible light. Light emitted from fluorescent layer 125 displays a visible image on PDP 100.

To increase the light emitting efficiency of a PDP, the space for generating a sustaining discharge must be large enough to excite a discharge gas, a surface area of a fluorescent layer must be wide, and structural configurations that hinder the emission of visible light from the fluorescent layer must be minimized.

In PDP 100, however, the space for generating the discharge is small because the sustaining discharge occurs only in a space between X electrode 112 and Y electrode 113 closed by protection layer 116, the corresponding surface area of fluorescent layer 125 is not especially wide, and the visible light that passes through upper substrate 111 is approximately 60% of the light emitted from fluorescent layer 125 because the visible light emitted from fluorescent layer 125 is absorbed and reflected by protection layer 116, upper dielectric layer 115, transparent electrodes 112b and 113b, and bus electrodes 112a and 113a.

Referring now to FIG. 2, in an effort to increase the surface area of fluorescent layer 125, a central barrier rib 126 may be formed in the sub-pixel, and fluorescent layer 125 may also be formed on side surfaces 128 of central barrier rib 126. This configuration is not desirable, however, because central barrier rib 126 can interrupt the sustaining discharge indicated by the arched arrows extending between X electrode 112 and Y electrode 113.

The present invention will now be described more fully with reference to the accompanying drawings in which exemplary embodiments of the invention are shown.

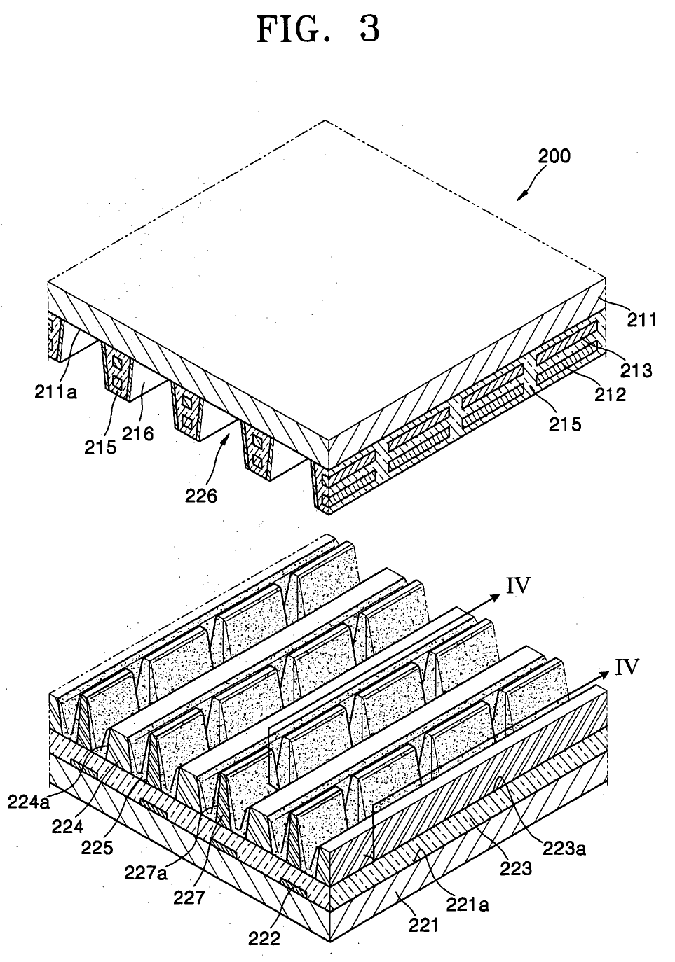

A first embodiment will now be described with reference to FIGS. 3 through 5.

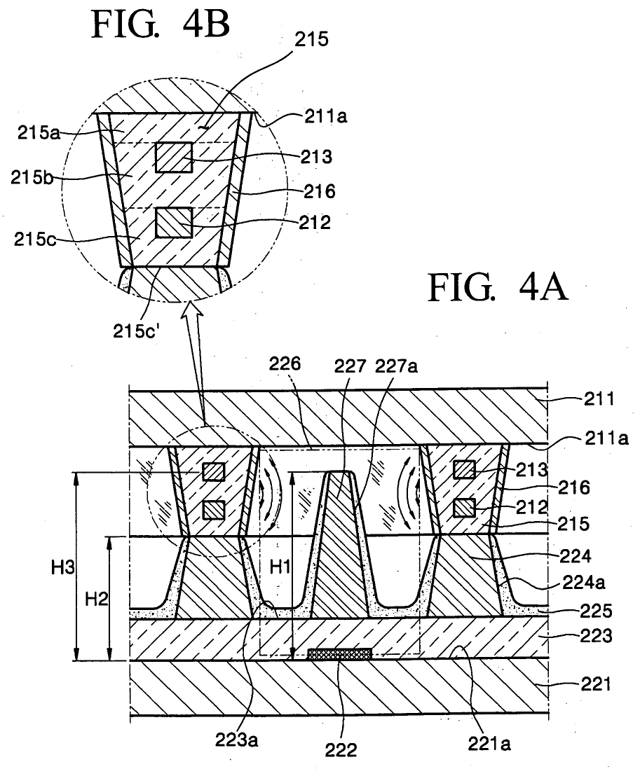

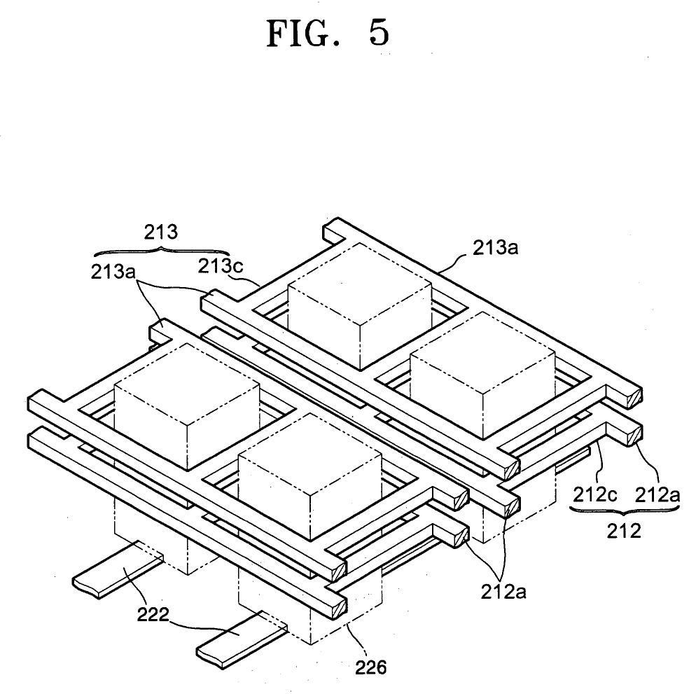

FIG. 3 is a cutaway exploded oblique view of a PDP according to one implementation of a first embodiment of the present invention, while FIG. 4 is a partial cross-sectional view taken along sectional line IV-IV of FIG. 3 and FIG. 5 is a partial oblique view illustrating the structure of electrodes in the PDP of FIG. 3.

A PDP 200 according to the first embodiment includes an upper substrate 211, an lower substrate 221 positioned within a plane parallel to a plane defined by upper substrate 211, a plurality of upper barrier ribs 215 descending downwardly from an undersurface of upper substrate 211, an upper discharge electrode 213 and a lower discharge electrode 212 embedded within each upper barrier rib 215, a plurality of lower barrier ribs 224 borne by and extending upwardly from lower substrate 221 toward corresponding ones of upper barrier ribs 215, a central barrier rib 227 centrally spaced-apart from neighboring lower barrier ribs 224, a fluorescent layer 225, and a discharge gas that fills the volume between lower surface 211a of upper substrate 211 and fluorescent layer 225. Lower barrier ribs 224 are aligned with upper barrier ribs 215 of define the interior volume of each discharge cell 226.

Lower substrate 221 is disposed in a parallel plane with a plane defined by upper substrate 211, and lower substrate 221 and upper substrate 211 are formed of a transparent material such as glass. No sustaining discharge electrode pair 114 such as is shown in FIGS. 1 and 2, is disposed on a lower surface of lower substrate 221 of the PDP, nor is an upper dielectric layer 115 such as is shown in FIGS. 1 and 2 which is used to cover sustaining discharge electrode pair 114, disposed on a portion of a lower surface 211a of upper substrate 211 that defines discharge cell 226. Therefore, more than eighty percent (80%) of visible light emitted from fluorescent layer 225, which will be described later, can be transmitted through upper substrate 211.

Upper barrier ribs 215 are formed of a dielectric material that together with upper substrate 211 and lower substrate 221 define discharge cells 226 that are formed on a lower surface 211a of upper substrate 211. In FIG. 5, discharge cells 226 are in an array of orthorhomboids or cubes disposed in a matrix shape, but the present invention is not limited thereto, and discharge cells 226 may have pyramidal shapes. Also, in FIG. 3, the cross-section of discharge cells 226 is rectangular, but the present invention is not limited thereto, and the cross-sectional shapes of discharge cells 226 may be polygonal such as a triangle or pentagon, or a curved geometric construct such as a circle or an oval, or discharge cells 226 may, in particular embodiments, have irregular and different cross-sectional shapes.

Upper barrier ribs 215 can be formed of a dielectric material that will prevent electrical short circuits from occurring between upper discharge electrode 213 and lower discharge electrode 212 which are adjacent to each other, and also can prevent damage to sustaining discharge electrodes 212, 213 when sustaining discharge electrodes 212, 213 collide with the charged particles. The dielectric material may be PbO, B₂O₃, or SiO₂.

Referring again to FIG. 3 together with FIG. 4, upper barrier ribs 215 may be covered by protection layer 216. Protection layer 216 may be formed by depositing MgO. When protection layer 216 is deposited, protection layer 216 may be deposited on a lower surface 215c′ of upper barrier ribs 215 (see FIGS. 4A, 4B) and on a lower surface 211a of upper substrate 211 that defines the discharge cells 226. Formation of protection layer 216 on lower surface 215c′ of upper barrier ribs 215 and on a lower surface 211a of upper substrate 211 does not adversely affect the operation of PDP 200 in the operation of the present embodiment. Moreover, formation of protection layer 216 on lower surface 215c′ of upper barrier ribs 215 and on lower surface 211a of upper substrate 211 can facilitate the emission of secondary electrons.

Referring again to FIGS. 4A, 4B in combination with FIGS. 3 and 5, upper discharge electrode 213 and lower discharge electrode 212 that surround discharge cells 226 are disposed spaced-apart from each other in upper barrier ribs 215. To dispose upper discharge electrode 213 and lower discharge electrode 212 in upper barrier ribs 215, a first upper barrier rib layer 215a is formed on lower surface 211a of upper substrate 211, upper discharge electrode 213 is formed on first upper barrier rib layer 215a, a second upper barrier rib layer 215b covering upper discharge electrode 213 is formed on first upper barrier rib layer 215a, lower discharge electrode 212 is formed on second upper barrier rib layer 215b, and a third upper barrier rib layer 215c covering lower discharge electrode 212 may be formed on second upper barrier rib layer 215b. Any of first upper barrier rib layer 215a, second upper barrier rib layer 215b, and third upper barrier rib layer 215c may be constructed in a stack of two, or more, layers if desired in a particular embodiment, for example, to make a thicker layer.

A sustaining discharge for displaying images is generated between upper discharge electrode 213 and lower discharge electrode 212. Upper discharge electrode 213 and lower discharge electrode 212 may be formed of an electrically conductive material such as a metal of aluminum, or copper, and address electrodes 222 which will be described later may also be formed of an electrically conductive material such as a metal.

Turning specifically to FIG. 3, lower discharge electrode 212 and upper discharge electrode 213 form pairs and extend in a direction parallel to each other. In PDP 200 when constructed as the present embodiment, lower discharge electrode 212, upper discharge electrode 213, and address electrodes 222 are disposed as depicted in FIG. 5, with lower discharge electrode 212 and upper discharge electrode 213 having their electrically conducting lengths, or rails, 212a, 213a and stiles 212c, 213c, respectively, formed in a ladder shape. Rails 212a, 213a of lower discharge electrode 212 and upper discharge electrode 213 are respectively electrically connected by stiles, or first connection units, 212c, 312c. Address electrodes 222 are disposed on an upper surface 221a of lower substrate 221 directly below a central barrier rib 227 that will be described later. First connection units 212c, 213c can respectively forestall a disconnection of lower discharge electrode 212 and upper discharge electrode 213 due to a localized open circuit failures that can occur during manufacturing and from an occurrence of non-uniform voltages along rails 212a, 213a caused by local discontinuities, irregularities or the non-uniform formation of lower discharge electrode 212 and upper discharge electrode 213. Address electrodes 222 extend across the widths of lower discharge electrode pairs 212 and upper discharge electrode pairs 213. This structure of electrodes enables a discharge to occur between one of upper discharge electrode 213 and lower discharge electrode 212 and address electrodes 222, and between upper discharge electrode 213 and lower discharge electrode 212.

Each discharge cell of a PDP operated by an address discharge and a sustaining discharge conventionally includes a pair of sustaining discharge electrodes respectively called X and Y electrodes, and an address electrode 222. The address discharge is a discharge occurring between the Y electrode and address electrode 222. Therefore, in the present embodiment, lower discharge electrode 212 can be the Y electrode when address electrode 222 is disposed beneath both upper discharge electrode 213 and lower discharge electrode 212, as shown in FIG. 5. If lower discharge electrode 212 is a Y electrode, upper discharge electrode 213 can be an X electrode.

In the present embodiment, upper discharge electrode 213 and lower discharge electrode 212 surround discharge cells 226 with their electrically conducting rails 212a, 213a and stiles 212c, 213c, respectively, unlike sustaining discharge electrodes 112 and 113 employed in convention PDP designs. Accordingly, the space for generating a sustaining discharge is relatively greater than can be provided by convention designs because the sustaining discharge occurs along a perimeter of the corresponding discharge cell 226. Therefore, the luminous efficiency of the PDP constructed as the present embodiment is greater than that of a PDP constructed in accordance with conventional principles of PDP design.

In discharge cells 226 of PDP 200 constructed according to the present embodiment, ion sputtering caused by the charged particles impinging onto fluorescent layer 225, which can occur during the sustaining discharge depicted by the curved arrows in FIG. 4A, may be reduced because the sustaining discharge occurs only in an upper part (that is, only on a portion of discharge cell 226 which is close to upper substrate 211), thereby reducing the generation of permanent image sticking created by the degradation of fluorescent layer 225 through ion sputtering.

Dielectric layer 223 is disposed between central barrier rib 227 and address electrode 222. Dielectric layer 223 prevents address electrode 222 from becoming damaged due to collisions with charged particles during discharge by covering address electrode 222. Dielectric layer 223 may be made from a material such as PbO, B₂O₃, or SiO₂ because dielectric layer 223 must be formed of a dielectric material that is able to induce charged particles.

Lower barrier ribs 224 are disposed between upper barrier ribs 215 and lower substrate 221; more specifically, lower barrier ribs 224 are positioned between upper barrier ribs 215 and dielectric layer 223. Lower barrier ribs 224 define regions of a fluorescent layer 225 that includes a red fluorescent material, a fluorescent layer that includes a blue fluorescent material, and a fluorescent layer that includes a green fluorescent material.

Lower barrier ribs 224 do not necessarily have the same shape as upper barrier ribs 215. As depicted in FIG. 3, in the present embodiment, lower barrier ribs 224 have a continuous stripe shape, which has an advantage of permitting an easy purge and discharge of impure gases and an easy filling of discharge cells 226 with a discharge gas during the PDP manufacturing process.

Although upper barrier ribs 215 and lower barrier ribs 224 have different shapes, they can be formed in one body. In FIG. 3, upper barrier ribs 215 are formed on a lower surface 211a of upper substrate 211 and lower barrier ribs 224 are formed on dielectric layer 223; lower barrier ribs 224 may alternatively be formed on a lower surface 215c′ (as is shown in FIGS. 4A, 4B) of upper barrier ribs 215. In the latter structure however, lower barrier ribs 224 have a tapered shape that grows narrower toward a lower direction, unlike the reversed tapered shape depicted in FIG. 3. For reference, formation of upper barrier ribs 215 and lower barrier ribs 224 in one body as an integrated monolithic structure does not mean that upper barrier ribs 215 and lower barrier ribs 224 are formed at the same time in a unitary process, but means that upper barrier ribs 215 and lower barrier ribs 224 can not separated without performing an additional step such as breaking upper barrier ribs 215 and lower barrier 224 apart along lower surface 215c′.

Referring again to FIGS. 4A and 4B, central barrier ribs 227 are disposed within discharge cells 226, and more specifically, are formed on a central portion of discharge cells 226. The height H1 of central barrier rib 227 is not less than the height H2 of lower barrier ribs 224, and height H1 is at least not less than the height H3 of upper discharge electrode 213. In the PDP depicted in FIG. 2, if central barrier rib 126 is disposed within a sub-pixel, the discharge route formed between the sustaining discharge electrodes 112, 113 is undesirably blocked by central barrier rib 126. In the present embodiment however, the discharge route formed between sustaining discharge electrodes 213 and 212 is not blocked because sustaining discharge electrodes 213, 212 are disposed beside discharge cells 226, that is, sustaining discharge electrodes 213, 212 both bound the periphery of each discharge cell 226. Consequently, no central barrier rib interrupts the path between neighboring sections of sustaining discharge electrodes 213, 212.

Fluorescent layer 225 is formed in each discharge cell 226, and, more specifically, is formed on an upper surface 223a of dielectric layer 223, on side surfaces 224a of lower barrier ribs 224, and on side surfaces 227a of central barrier rib 227. Fluorescent layer 225 is formed by coating a fluorescent paste, in which a fluorescent material for emitting red light, a fluorescent material for emitting blue light, and a fluorescent material for emitting green light are mixed in solvent and a binder, onto an upper surface 223a of dielectric layer 223, onto side surfaces 224a of lower barrier ribs 224, and onto side surfaces 227a of central barrier rib 227, and then drying and baking the fluorescent layer coating. The fluorescent materials for emitting red light may be Y(V,P)O₄:Eu; for blue light the fluorescent material may be BAM:Eu; and the fluorescent material for green light may be Zn₂SiO₄:Mn, and YBO₃:Tb.

First, it should be appreciated that in the present embodiment, the surface area of fluorescent layer 225 is wide and substantially large because fluorescent layer 225 is formed not only on side surfaces 224a of lower barrier ribs 224, but also on side surfaces 227a of central barrier rib 227. Therefore, the aggregate area able to emit visible light in response to reception of ultraviolet rays generated from a discharging gas impinging upon fluorescent layer 225 which will be described later, is substantially increased. Second, fluorescent layer 225 formed on side surfaces 227a of central barrier rib 227 can receive a large substantial quantity of ultraviolet irradiation because side surfaces 227a are close to the discharging space (see the encircled extract indicated by the arrow in FIGS. 4A, 4B), thereby increasing the amount of visible light emitted. These two observations significantly increase the luminous efficiency of PDP 200.

If height H1 of central barrier rib 227 is not less than height H3 of upper discharge electrode 213, the utilization of the ultraviolet rays that excite the fluorescent material in layer 225 will be maximized because the ultraviolet rays emanate mainly in response to discharges from the discharge gas filling the volume of each cell 226 in those regions which are closest to upper discharge electrode 213 and lower discharge electrode 212.

A discharge gas fills the volume formed by each discharge cell 226. The discharge gas may be a Ne—Xe mixed gas that includes 5-15% of Xe, but if necessary, a portion of Ne may be replaced by He.

The operation of PDP 200 will now be described. An address discharge occurs between address electrode 222 and lower discharge electrode 212 by applying an address voltage Va therebetween, and a discharge cell 226 in which a sustaining discharge may occur is selected as the result of the address discharge. The selection of discharge cell 226 denotes the accumulation of wall charges on upper barrier ribs 215 (or, if upper barrier ribs 215 are covered by protection layer 216, the accumulation of wall charges is on protection layer 216) so that an electrical discharge can occur on a region close to upper discharge electrode 213 and lower discharge electrode 212 as indicated by the curved arrows in FIG.4. When the address discharge occurs, positive ions accumulate on a region adjacent to lower discharge electrode 212, and electrons accumulate on a region close to upper discharge electrode 213.

After the address discharge terminates when a sustaining discharge voltage Vs is applied between lower discharge electrode 212 and upper discharge electrode 213 of a selected discharge cell 226, a sustaining discharge occurs in response to collisions between the positive ions that have accumulated on a region adjacent to lower discharge electrode 212 and the electrons that have accumulated on a region adjacent to upper discharge electrode 213. As the sustaining discharge proceeds, a reversed sustaining discharge voltage Vs is repeatedly applied between lower discharge electrode 212 and upper discharge electrode 213.

The energy level of the discharge gas is increased by the sustaining discharge, and ultraviolet rays are emitted by the discharging gas, thereby reducing the increased energy level of the discharge gas to the energy level held prior to the sustaining discharge. The ultraviolet rays increase the energy level of a fluorescent material included in fluorescent layer 225 disposed in the corresponding discharge cell 226, and a visible light is emitted while the energy level of the fluorescent material concomitant decreases. A colored visible image is displayed on PDP 200 as a result of the visible light emitted from discharge cells 226.

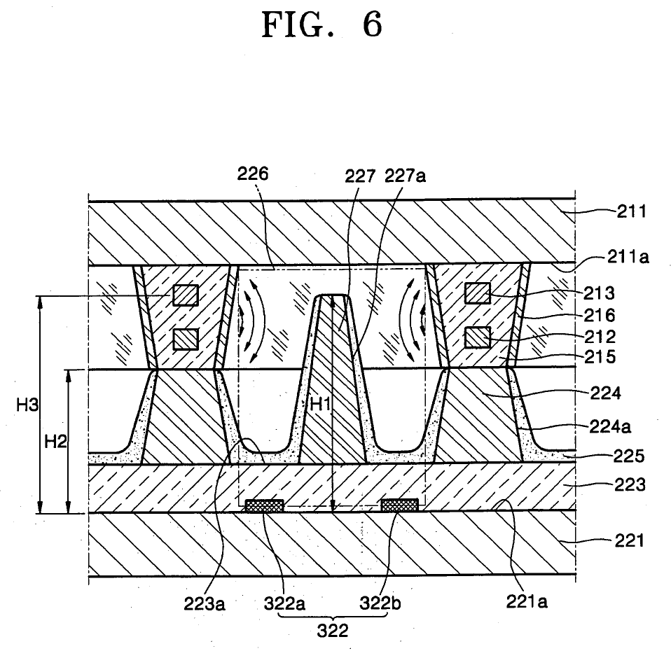

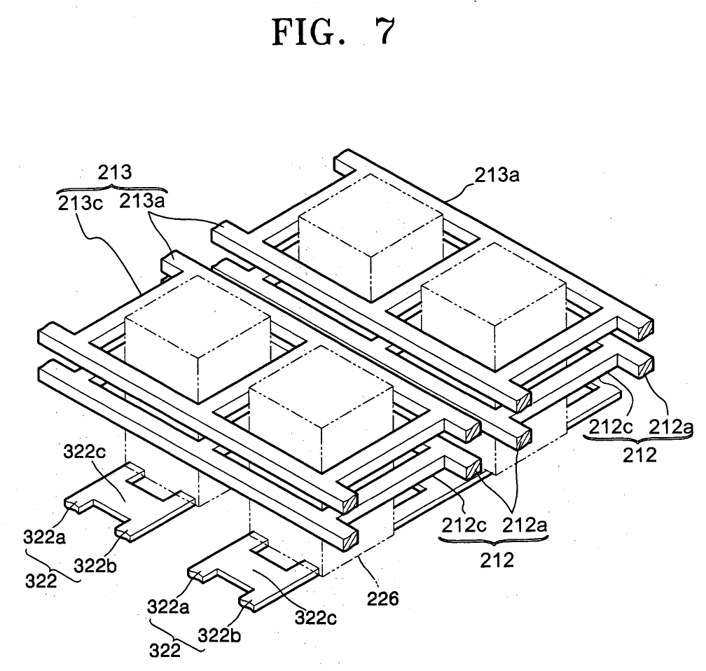

A first modified version of the first embodiment will now be described with reference to FIGS. 6 and 7.

FIG. 6 is a cross-sectional view of a first modified version of the first embodiment described in the foregoing paragraphs, while FIG. 7 is a partial oblique view illustrating the structures of the electrodes incorporated into the first modified version of the first embodiment.

One principal difference between the first modified version of the first embodiment from the first embodiment is that each address electrode 322 disposed in a discharge cell 226 may have two substantially parallel, electrically connected sub-address electrodes 322a and 322b, and each of sub-address electrodes 322a and 322b are disposed on an upper surface 221a of lower substrate 221, with one sub-address electrode 322a, 322b aligned in between central barrier rib 227 and lower barrier ribs 324. Address electrode 322 is embedded in dielectric layer 223.

Address electrode 322 together with lower discharge electrode 212 generates an address discharge. Therefore, the address discharge is improved when one rail 322a, 322b of each address electrode 322 is disposed on an upper surface 221a of lower substrate 221 in-between each central barrier rib 227 and the neighboring lower barrier rib 324 over the discharge that is provided when address electrode 322 is disposed directly below central barrier rib 227.

The two sub-address electrodes 322a and 322b can be connected by stiles, or first connection units 322c. First connection units 322c can forestall a disconnection of sub-address electrodes 322a, 322b due to a localized failure that can occur during manufacturing and an occurrence of non-uniform voltages between sub-address electrodes 322a, 322b caused by local discontinuities, irregularities or the non-uniform formation of sub-address electrodes 322a, 322b. In FIG. 7, first connection unit 322c is disposed on the outside of discharge cell 226, but first connection unit 322c may alternatively be disposed inside discharge cell 226.

Elements that are not described in the first modified version are substantially identical to the comparable elements described and illustrated in the foregoing description of the first embodiment.

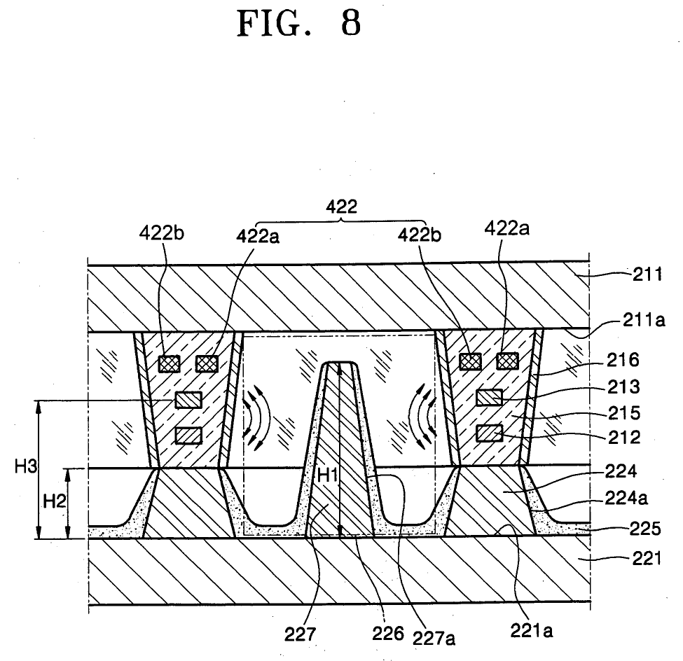

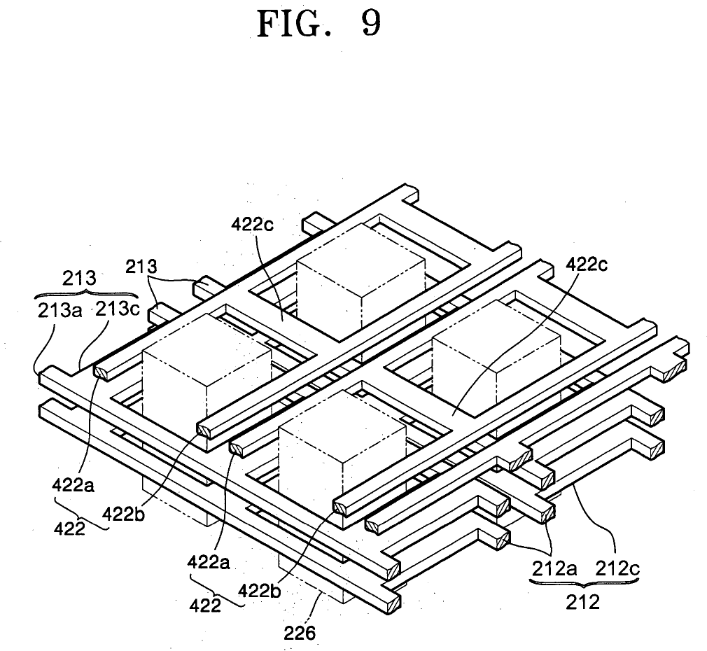

A second modified version of the first embodiment will now be described with reference to FIGS. 8 and 9.

FIG. 8 is a cross-sectional view of a second modified version of the first embodiment, while FIG. 9 is a partial oblique view illustrating the structure of the electrodes in the second modified version of the first embodiment.

The principal differences between the second modified version of the first embodiment and the first embodiments is that address electrodes, 422 are embedded within upper barrier ribs 215 and include two substantially parallel sub-address electrodes 422a, 422b, or rails, separated from lower discharge electrode 212 and upper discharge electrode 213. Two sub-address electrodes 422a, 422b are embedded in each upper barrier rib 215, with the two sub-address electrodes 422a, 422b corresponding to an address electrode 422 positioned within different upper barrier ribs 215, on opposite sides of each discharge cell 226.

Address electrode 422 together with either one of lower discharge electrode 212 and upper discharge electrode 213 generates an address discharge. Therefore, when address electrode 422 is embedded within upper barrier ribs 215 as in the second modified version, the reliability of the address discharge is improved in comparison to a design where address electrode 422 is disposed directly below central barrier rib 227.

The two sub-address electrodes 422a, 422b may be connected by a second connection unit 422c, so that each address electrode 422 effectively surrounds the peripheries of all of the discharge cells within the corresponding row, as is shown by FIG. 9. Second connection unit 422c can solve a disconnection problem of sub-address electrodes 322a, 322b due to a localized failures that may occur during manufacture while preventing occurrences of non-uniform voltage between sub-address electrodes 422a, 422b caused by non-uniform formation and irregularities in the structures of sub-address electrodes 422a, 422b. Also, with this configuration the address discharge can be generated along four successive surfaces forming the periphery of discharge cell 226 by controlling the distance, between sub-address electrodes 422a, 422b, 422c and the walls of discharge cell 226.

In FIGS. 8 and 9, address electrode 422 is disposed above upper discharge electrode 213, but address electrode 422 may alternatively be disposed below lower discharge electrode 212. When address electrode 222 is disposed above upper discharge electrode 213, an address discharge can be generated between address electrode 422 and upper discharge electrode 213. On the other hand, when address electrode 422 is disposed below lower discharge electrode 212, an address discharge can be generated between lower discharge electrode 212 and address electrode 422. In order to excite uniformly a lot of the discharge gas filled in discharge cell 226, however, it is advantageous to position address electrode 422 above upper discharge electrode 213 because it is desirable that upper discharge electrode 213 and lower discharge electrode 212 are located in the center of discharge cell 226 in a vertical alignment. Wherever address electrode 422 is disposed, address electrode 422 is separated and electrically insulated from both upper discharge electrode 213 and lower discharge electrode 212.

Elements that have not been fully described in the foregoing description of the second modified version are substantially identical to the elements of the first embodiment.

A third modified version of the first embodiment will now be described. The principal differences between the third modified version of the first embodiment and the first embodiment is that there is no address electrode 222 present in the third modified version. Address electrode 422 is not a requisite to the generation of a discharge because two discharge electrodes are able to generate a discharge in any particular discharge cell 226.

When there is no address electrode 222, upper discharge electrode 213 is extended in one direction and lower discharge electrode 212 is extended in a perpendicular direction to cross upper discharge electrode 213. Dielectric layer 223 is also not necessary because there is no address electrode 222. Therefore, lower barrier rib 224 is formed on an upper surface 221a of lower substrate 221 and fluorescent layer 225 is formed on side surfaces 224a of lower barrier rib 224, side surfaces 227a of central barrier rib 227, and an upper surface 221a of lower substrate 221.

Elements that are not fully described in the detailed description of the third modified version are substantially identical to the elements of the first embodiment.

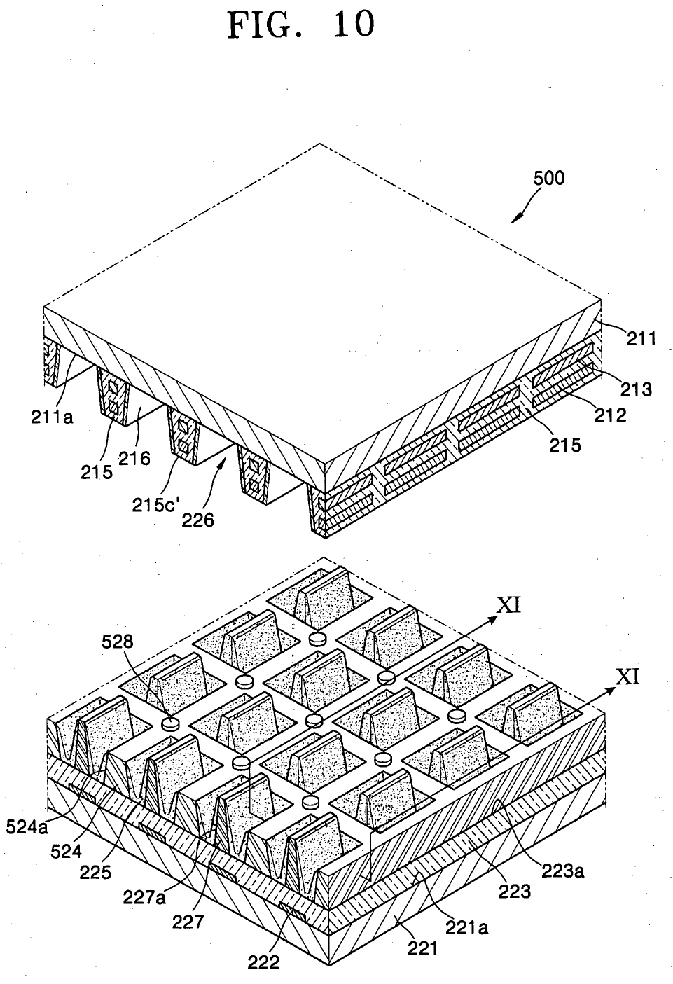

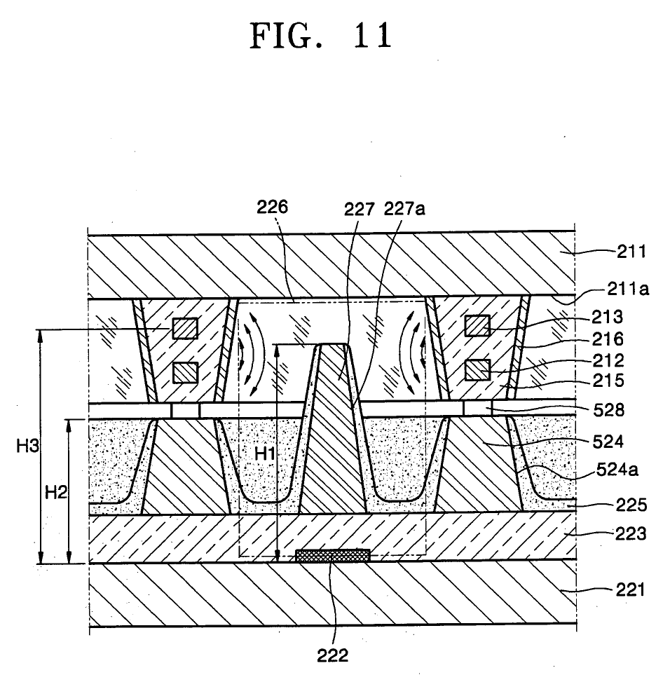

A second embodiment of the present invention will now be described with reference to FIGS. 10 and 11, mainly to emphasize the principal differences from the first embodiment,

FIG.10 is a cutaway, partially exploded oblique view of a PDP constructed according to a second embodiment of the present invention, while FIG. 11 is a partial cross-sectional view taken along sectional line XI-XI of FIG. 10.

One difference between the first and second embodiments is that in the construction of the second embodiments, lower barrier ribs 524 are formed in the same pattern as upper barrier ribs 215. Referring to FIG. 10, upper barrier ribs 215 define closed spaces in a horizontal direction, and lower barrier ribs 524 of the present embodiment also define closed spaces in a horizontal direction. In this embodiment, the area of side surface 524a of lower barrier ribs 524 is increased, and accordingly the area of fluorescent layer 225 is concomitantly increased. As a result, the amount of visible light emitted from a discharge cell 226 is also increased, thereby improving the luminous efficiency of PDP 500.

In the present embodiment, upper barrier ribs 215 and lower barrier ribs 524 may be either formed in one unitary body as an integrated monolithic structure, or alternatively, may be either formed separately and independently. When upper barrier ribs 215 and lower barrier ribs 524 are formed separately, spacers 528 may be disposed between upper barrier ribs 215 and lower barrier ribs 524. Spacers 528 facilitate the exhaustion of impurities and gases, and the filling of a discharge gas during the PDP manufacturing process by maintaining a space between upper barrier ribs 215 and lower barrier ribs 524. In FIG. 10, spacers 528 are formed on lower barrier ribs 524; alternatively, spacers 528 can be formed on a lower surfaces 215c′ of upper barrier ribs 215.

When upper barrier ribs 215 and lower barrier ribs 524 are formed in one body with the same patterns in upper barrier ribs 215 and lower barrier ribs 524, the determination of the boundary line between upper barrier ribs 215 and lower barrier ribs 524 is difficult. In this case, a mid-point of the height of the integrated barrier ribs 215, 524 selected between upper barrier ribs 215 and lower barrier ribs 524 may be considered as the plane of an arbitrary boundary line.

The second embodiment can also be modified in accordance with the modifications of the first embodiment. Elements that have not been fully described in the foregoing illustrations and detailed description of the second embodiment are substantially identical to the comparable elements of the first embodiment.

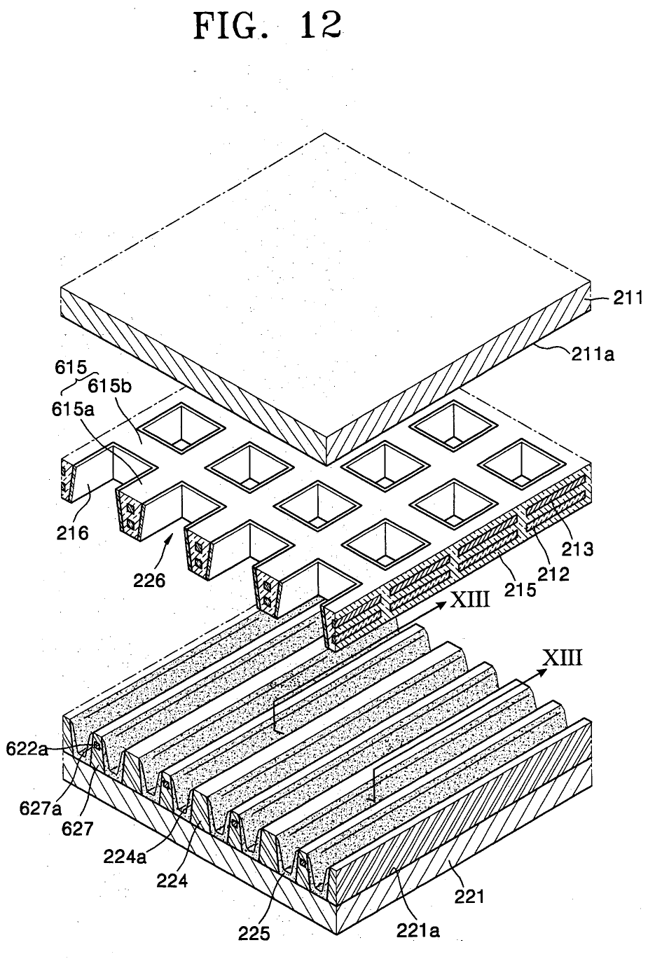

A third embodiment of the present invention will now be described with reference to FIGS. 12 though 14, to mainly the principal differences between the first and second embodiments.

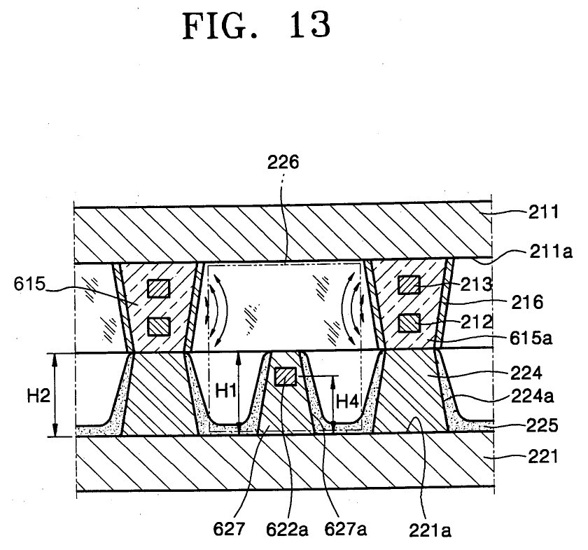

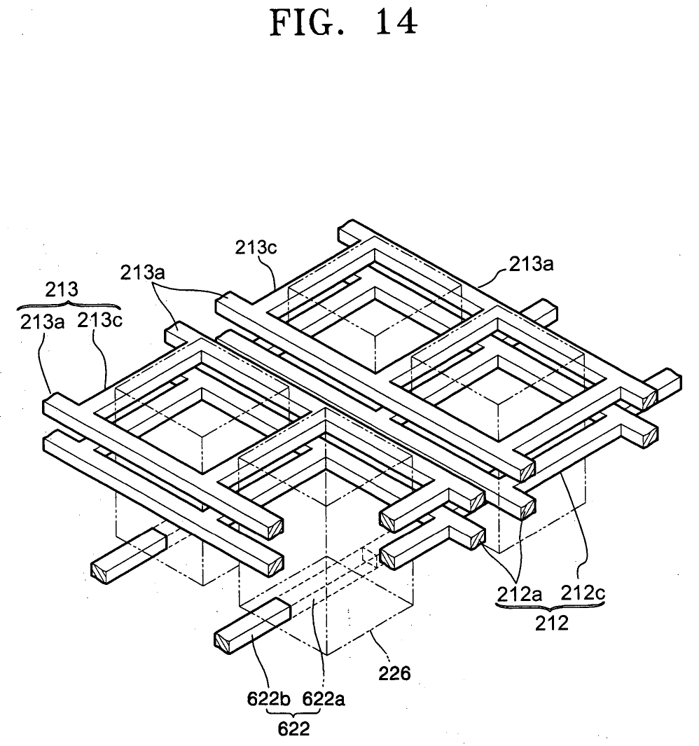

FIG. 12 is a cutaway partially exploded oblique view of a PDP constructed as a third embodiment of the present invention, while FIG. 13 is a partial cross-sectional view taken along sectional line XIII-XIII of FIG. 12, and FIG. 14 is a partial oblique view illustrating the structure of electrodes in the PDP of FIG. 12.

In the third embodiment, heights H1 of central barrier ribs 627 are substantially equal to the heights H2 of lower barrier ribs 224. Also, upper barrier ribs 615 that include first extension walls 615a and second extension walls 615b obliquely intersecting and crossing first extension walls 615a, together with upper and lower substrates 211 and 221 define an ordered array of discrete discharge cells 226. Upper barrier ribs 215 and lower barrier ribs 224 are formed of a dielectric material disposed between upper and lower substrates 211 and 221, more specifically, on lower surface 211a of upper substrate 211. In FIG. 12, discharge cells 226 are disposed in an orthogonal array matrix shape, but they are not limited to this particular shape and can be disposed in a triangular shape.

In a conventional design for a PDP, two substrates 111, 121 have to be sealed after performing a process for forming upper substrate 111 and a separate process for forming lower substrate 121 because different elements are disposed on the underside of surface 111a of upper substrate 111 and the upper side of surface 221a of lower substrate 121. When upper barrier ribs 615 and lower barrier ribs 224 are formed in one body as a single, unified and monolithic structure with lower substrate 221, the process for forming upper substrate 211 becomes unnecessary, thereby simplifying the process of forming the PDP.

Central barrier ribs 627 may be extended in a direction of address electrodes 622, that is, parallel to and spaced-apart from lower barrier ribs 224, and parallel to first extension unit 615a because the aggregate central barrier ribs 627 increase the luminous efficiency by expanding a surface area of fluorescent layer 225, which will be described later; the placement of central barrier ribs 627 must protect discharge units 622a of address electrodes 622 from damage which could be caused by ion sputtering.

Referring to FIG. 13, discharge sections 622a of address electrode 622 are disposed in central barrier rib 627. Referring to FIG. 14, address electrode 622 includes discharge sections 622a embedded within central barrier rib 627 and horizontal connection sections 622b that underlie transverse upper barrier walls 615b to electrically connect the discharge sections 622a underlying discharge cells 226, and to extend orthogonally across the lengths, or rails 212a, 213a, respectively, of lower discharge electrode 212 and upper discharge electrode 213. Lower discharge electrode 212 and upper discharge electrode 213 form pairs and extend in a direction parallel to each other. Rails 212a, 213a of lower discharge electrode 212 and upper discharge electrode 213 are respectively electrically connected by stiles, or first connection units, 212c, 312c. Lower discharge electrode 212 and upper discharge electrode 213 have their electrically conducting rails 212a, 213a and stiles 212c, 213c, respectively, formed in a ladder shape. First connection units 212c, 213c can respectively forestall a disconnection of lower discharge electrode 212 and upper discharge electrode 213 due to localized open circuit failures that can occur during manufacturing and from an occurrence of non-uniform voltages along rails 212a, 213a caused by local discontinuities, irregularities or the non-uniform formation of lower discharge electrode 212 and upper discharge electrode 213.

Discharge sections 622a of address electrode 622 together with lower discharge electrode 212, generate an address discharge. Therefore, the closer discharge sections 622a of address electrode 622 are positioned to lower discharge electrode 212, the more address voltage Va may be reduced in magnitude. The low address voltage effectively reduces power consumption, which produces an increase in luminous efficiency. Therefore, it is desirable to position discharge sections 622a in an upper part of central barrier ribs 627, and in this case, height H4 of discharge sections 622a will satisfy the inequality H4>(H/2).

Lower dielectric layer 123, which is included in a conventional PDP, is unnecessary in the practice of this embodiment because address electrode 622 is embedded within central barrier ribs 627.

Fluorescent layer 225 is disposed in discharge cells 226, more specifically, on side surfaces 227a of central barrier ribs 227 and side surfaces 224a of lower barrier ribs 224. Fluorescent layer 225 can be formed on an upper surface 221a of lower substrate 221, but fluorescent layer 225 may not be formed when lower barrier rib 224 and central barrier ribs 227 are disposed too close to each other.

Elements that are not fully described in the foregoing illustrations and detailed description of this third embodiment, are substantially identical to the elements of the first embodiment.

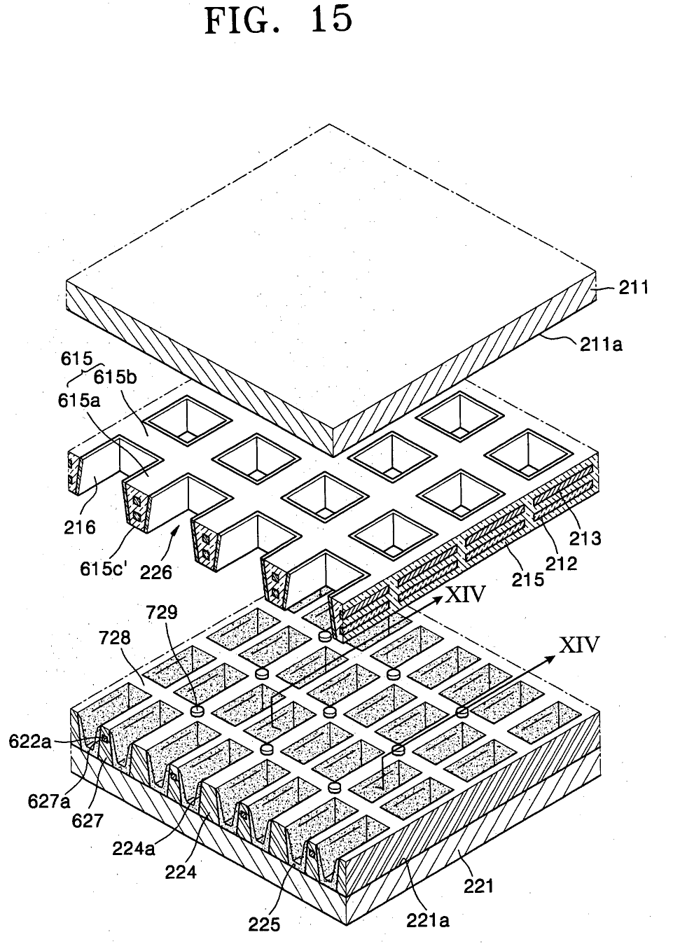

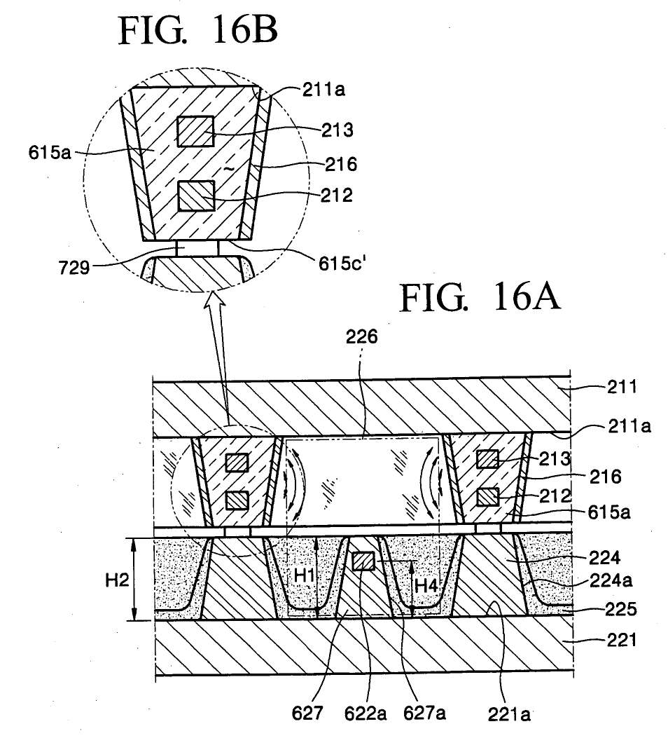

A modified version of the third embodiment of the present invention, principally the differences between the third embodiment and this modified version, will now be described with reference to FIGS. 15, 16A and 16B.

FIG. 15 is a cutaway exploded oblique view of a PDP constructed as a modified version of the third embodiment of the present invention, while FIGS. 16A, 16B are a partial cross-sectional views taken along sectional line XVI-XVI of FIG. 15.

The principal differences between this modified version of the third embodiment and the third embodiment include auxiliary barrier ribs 728 disposed between second extension walls 615b and lower substrate 221. More specifically, auxiliary barrier ribs 728 are formed on an upper surface 221a of lower substrate 221, and fluorescent layer 225 is formed on side surfaces of auxiliary barrier ribs 728. The surface area of fluorescent layer 225 is wider because fluorescent layer 225 is formed on side surfaces of auxiliary barrier ribs 728, thereby increasing the emission of visible light and concomitantly improving the luminous efficiency of the PDP.

When the height of auxiliary barrier ribs 728 is designed to be identical to the height of lower barrier ribs 224, an additional process for forming auxiliary barrier ribs 728 is unnecessary because auxiliary barrier ribs 728 may be formed simultaneously with the formation of lower barrier rib 224. Lower barrier ribs 224, central barrier ribs 627, and auxiliary barrier ribs 728 may be formed in one integrated, monolithic body.

First extension walls 615a of upper barrier ribs 215 and lower barrier ribs 224 may be separately formed. When first extension unit 615a and lower barrier rib 224 are formed separately, second extension walls 615b and auxiliary barrier ribs 728 may also be formed separately, and when first extension walls 615a and lower barrier ribs 224 are formed in one body, second extension walls 615b and auxiliary barrier ribs 728 may also be formed in one integrated, monolithic body.

The modified version depicted in FIGS. 15, 16A and 16B is the resulting structure when first extension walls 615a and the lower barrier ribs 224 are formed separately, that is, when second extension walls 615b and auxiliary barrier ribs 728 are formed separately. In this structure, spacers 729 can be disposed between first extension walls 615a and lower barrier ribs 224 or alternatively, between second extension walls 615b and auxiliary barrier ribs 728. Spacers 729 facilitate the extraction of impure gases and the filling of a discharge gas during the PDP manufacturing process by maintaining a space between upper barrier ribs 215 and lower barrier ribs 224. In FIG. 15, spacers 729 are shown formed on lower barrier ribs 224; alternatively, spacers 729 can be formed on lower surfaces 615c′ of upper barrier ribs 615.

When first extension walls 615a and lower barrier ribs 224 are formed in one monolithic body (and second extension walls 615b and auxiliary barrier ribs 728 are formed in one monolithic body), there are no spacers 729, first extension walls 615a is formed on lower barrier rib 224 and second extension walls 615b is formed on auxiliary barrier ribs 728. In this structure, the cross-section of first extension walls 615a and second extension walls 615b have a tapered shape, that is, upper portions of first extension walls 615a and second extension walls 615b are gradually narrowed as the distance of extension walls 615a, 615b from lower substrate 221 is increased unlike the structure depicted in FIGS. 15, 16A and 16B. In these structures, the precise determination of the boundary line between upper barrier ribs 215 and lower barrier ribs 224, or between second extension walls 615b and auxiliary barrier ribs 728 may be difficult. In these structures, second extension unit 615b and auxiliary barrier ribs 728 may optionally be arbitrarily divided at a mid-point of the height of the barrier rib formed in one body with first extension unit 615a and lower barrier rib 224 and at a mid-point of the height of the barrier rib formed as one body with second extension walls 615b and auxiliary barrier ribs 728.

Elements that may not be fully illustrated or described in this modified version of the third embodiment are substantially identical to the elements of the third embodiment that have been illustrated and described in the foregoing paragraphs.

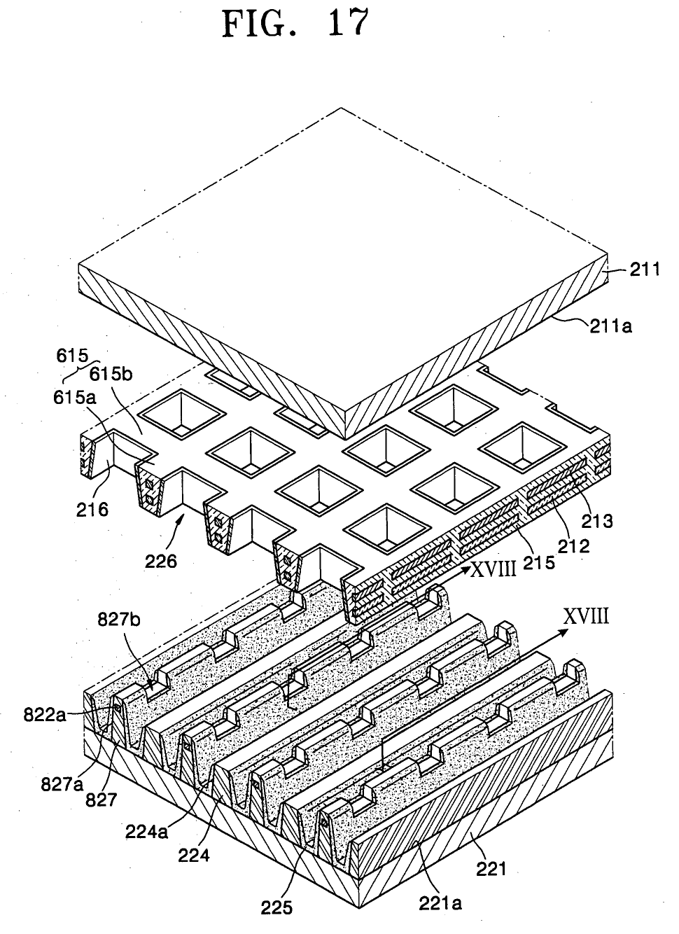

The principal differences between the third embodiment and a fourth embodiment will now be described with reference to FIGS. 17 though 19.

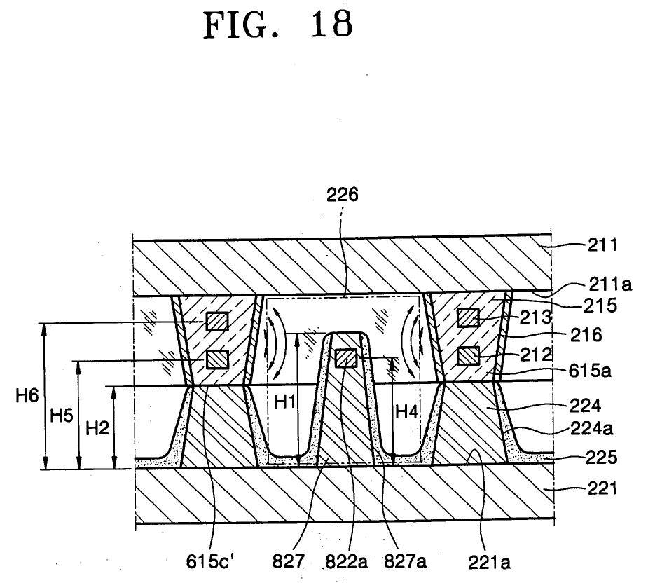

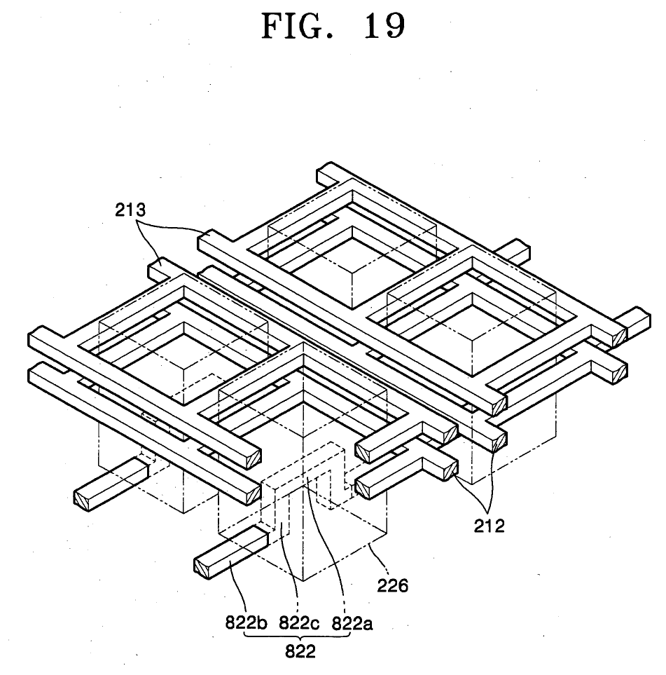

FIG. 17 is a cutaway exploded oblique view of a PDP constructed as a fourth embodiment of the present invention, while FIG. 18 is a partial cross-sectional view taken along sectional line XVIII-XVIII of FIG. 17, and FIG. 19 is a partial oblique view illustrating the structures of the electrodes in the PDP of FIG. 17.

One difference between the third and fourth embodiments is that height H1 of central barrier ribs 827 is not less than the height H5 of lower discharge electrodes 212.

If height H1 of central barrier ribs 827 is increased, the surface area of fluorescent layer 225 formed on side surfaces 827a of central barrier ribs 827 increases accordingly, thereby improving the luminous efficiency. Also, the excitation of the phosphor can be maximized when height H1 of central barrier ribs 827 is close to the height of upper discharge electrode 213 because ultraviolet rays are intensively emitted from the discharge gasfilling the volume of the discharge cell 226 adjacent to upper discharge electrode 213 and lower discharge electrode 212.

FIG. 18 shows that height H4 of discharge section 822a of address electrode 822 is equal to the height H5 of lower discharge electrode 212, but this configuration is appropriate when the address discharge occurs between a discharge section 822a of address electrode 822 and lower discharge electrode 212. When the address discharge occurs between a discharge section 822a of address electrode 822 and upper discharge electrode 213, it is desirable that the height H3 of discharge section 822a of address electrode 822 be equal to the height H6 of upper discharge electrode 213.

If the height H1 of central barrier ribs 827 is increased, discharge section 822a of address electrode 822 may be positioned higher (i.e., farther from lower substrate 211) than in the third embodiment. Therefore, height H4 of discharge section 822a of address electrode 822 may be equal to the height H5 of lower discharge electrode 212 or height H6 of upper discharge electrode 213. In this structure, the distance for address discharging is reduced, thereby further reducing the address voltage Va, which will concomitantly reduce the power consumption and provide an increase in luminous efficiency.

As illustrated by FIGS. 17 and 18, a portion of central barrier rib 827 located inside of each discharge cell 226 may be extended to a greater height H1 in a higher position than the height H2 of a lower surface 615c′ on the lowermost extremity of upper barrier rib 215, but the other portion of upper barrier rib 215 located outside of discharge cell 226 should not be extended to a height that is higher than lower surface 615c′ of upper barrier rib 615 in order to accommodate the lowermost portion of second extension walls 615b. Therefore, a concave recess 827b, into which the lowermost portion of second extension unit 615b of upper barrier rib 615 is accommodated, is formed along the upper portion of central barrier rib 827 that is located outside of discharge cell 226.

Referring to FIGS. 17,18 and 19, when height H4 of discharge section 822a of address electrode 822 is higher than the height H2 of the lower surface 615c′ of upper barrier rib 215, a horizontal connection unit 822b that electrically connects discharge units 822a must be disposed at a lower height than the height H2 of lower surface 516c′ of upper barrier rib 215. In this case, discharge unit 822a and horizontal connection unit 822b are electrically connected together by a vertical connection unit 822c, and vertical connection unit 822c is disposed inside of the portion of central barrier rib 827 that is erected inside discharge cell 226, as is depicted by FIG. 19.

The fourth embodiment can also be modified in a manner similar to the third embodiment. Elements that are not fully illustrated and described in this description of the fourth embodiment are substantially identical to the comparable elements of the third embodiment.

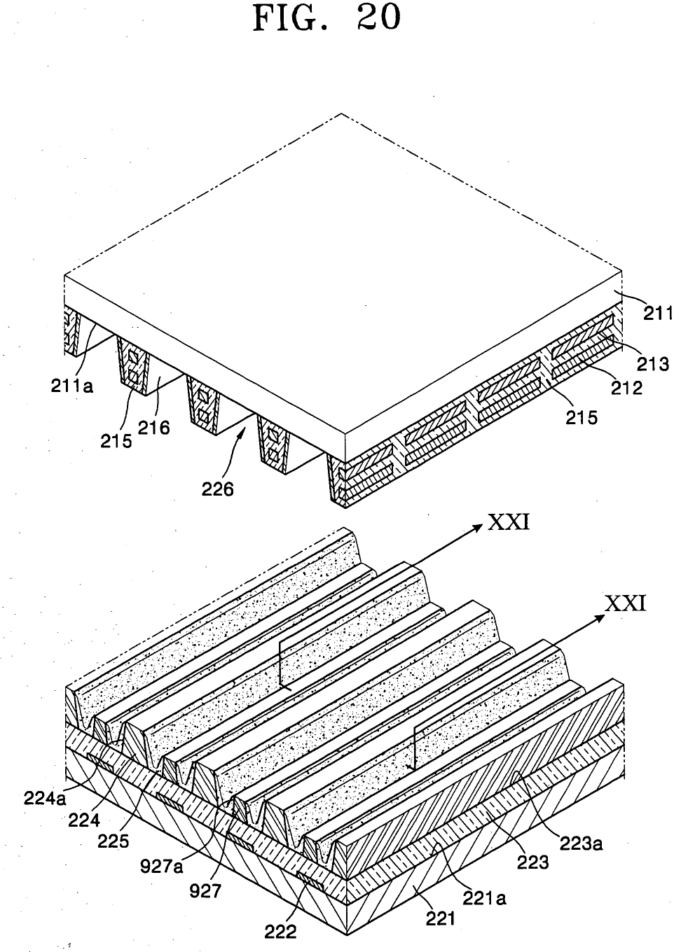

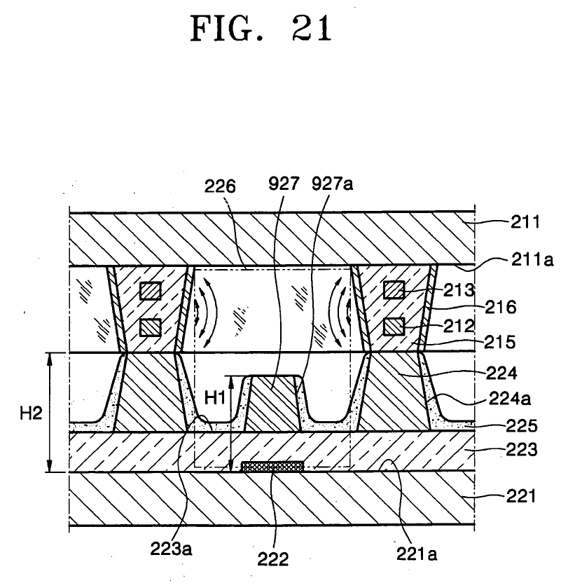

The principal differences between a fifth embodiment of the present invention and the previous embodiments, will now be described with reference to FIGS. 20 and 21.

FIG. 20 is a cutaway exploded oblique view of a PDP constructed as a fifth embodiment of the present invention, while FIG. 21 is a partial cross-sectional view taken along sectional line XXI-XXI of FIG. 20.

One difference between the present embodiment and previous embodiments is that height H1 of central barrier ribs 927 may be lower than the height H2 of lower barrier ribs 224.

The light emission efficiency of the PDP will be improved because greater surface area is made available for the deposition of fluorescent layer 225 by the formation of side surfaces 927a of central barrier rib 927. Also, central barrier rib 927 is not significantly located within the portion of discharge cell 226 where the discharge occurs intensively because the height of central barrier rib 927 is low. Therefore, a plasma discharge can occur fluently within the volume of discharge cell 226 because the possibility of reducing space particles generated during plasma discharge is reduced.

Elements of the fifth embodiment that have not been fully illustrated or described in the drawings and the foregoing paragraphs are substantially identical to the corresponding elements of the previous embodiments.

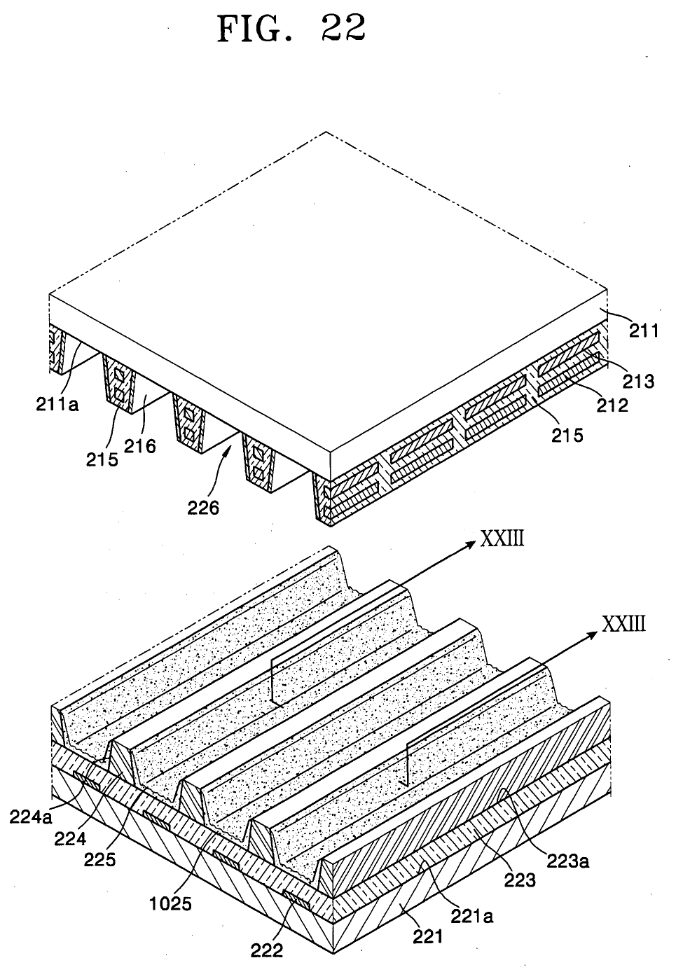

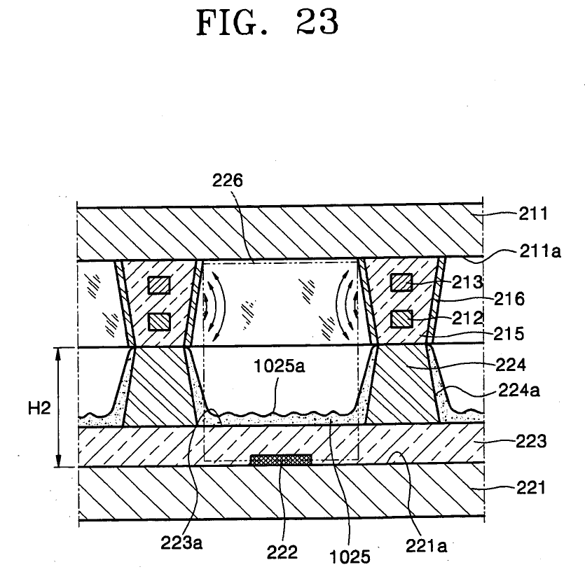

The principal differences between the previous embodiments and the sixth embodiment of the present invention, will now be described with reference to FIGS. 22 and 23.

FIG. 22 is a cutaway exploded oblique view of a PDP constructed according to a sixth embodiment of the present invention, while FIG. 23 is a partial cross-sectional view taken alongsectonal line XXIII-XXIII of FIG. 22.

One difference between the present embodiment and the previous embodiments is that no central barrier rib is necessary in the practice of the sixth embodiment.

In a conventional design for a PDP, there is a problem attributable to the insufficiency of the surface area of fluorescent layer 125 due to the smoothness of the surface of fluorescent layer 125. In the PDP constructed according to the sixth embodiment however, protrusions 1025a caused by irregularities and undulations in the thickness of the surface area of fluorescent layer 1025 that are struck by the ultraviolet rays, effectively increase the surface area of fluorescent layer 1025. Therefore, the emission of visible light is increased because a collision between the ultraviolet rays and fluorescent layer 1025 is more effectively achieved by the increased surface area of fluorescent layer 1025. Therefore, the luminous efficiency of the PDP is improved.

Elements of the sixth embodiment that are not fully illustrated or described in the drawings and the foregoing paragraphs, are substantially identical to the elements of the previous embodiments.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A plasma display panel (PDP), comprising:
an upper substrate;
a lower substrate disposed parallel to the upper substrate;
a plurality of upper barrier ribs formed of a dielectric disposed between the upper substrate and the lower substrate, with the upper barrier ribs, the upper substrate and the lower substrate collectively defining a plurality of discharge cells;
a plurality of upper discharge electrodes disposed in the upper barrier ribs to surround the discharge cell;
a plurality of lower discharge electrodes separated from the upper discharge electrodes and disposed in the upper barrier ribs to surround the discharge cell;
a plurality of lower barrier ribs disposed between the upper barrier ribs and the lower substrate;
a plurality of central barrier ribs disposed in the discharge cells;
a plurality of fluorescent layers formed between side surfaces of the lower barrier ribs and side surfaces of the central barrier ribs; and
a discharge gas filling the discharge cell.

2. The plasma display panel of claim 1, wherein the height of the central barrier ribs is lower than the height of the lower barrier ribs.

3. The plasma display panel of claim 1, wherein the height of the central barrier ribs is substantially equal to the height of the lower barrier ribs.

4. The plasma display panel of claim 1, wherein the height of the central barrier ribs is higher than the height of the lower barrier ribs.

5. The plasma display panel of claim 4, wherein the height of the central barrier ribs is not less than the height of the upper discharge electrodes.

6. The plasma display panel of claim 1, wherein the central barrier rib is disposed in the center of the discharge cell.

7. The plasma display panel of claim 1, wherein the lower barrier ribs and the central barrier ribs are formed on an upper surface of the lower substrate.

8. The plasma display panel of claim 1, wherein the upper barrier ribs includes a first extension unit and a second extension unit that crosses the first extension unit.

9. The plasma display panel of claim 8, wherein the central barrier ribs are parallel to the first extension unit.

10. The plasma display panel of claim 8 further comprising an auxiliary barrier rib disposed between the second extension unit and the lower substrate and the fluorescent layer is further formed on side surfaces of the auxiliary barrier rib.

11. The plasma display panel of claim 10, wherein the height of the auxiliary barrier rib is equal to the height of the lower barrier ribs.

12. The plasma display panel of claim 10, wherein the lower barrier ribs, the central barrier ribs, and the auxiliary barrier ribs are formed in one body.

13. The plasma display panel of claim 10, wherein a spacer is disposed between the first extension unit and the lower barrier rib or between the second extension unit and the auxiliary barrier rib.

14. The plasma display panel of claim 10, wherein the first extension units and the lower barrier ribs are formed in one body and the second extension units and the auxiliary barrier ribs are formed in one body.

15. The plasma display panel of claim 8, wherein the height of a portion of the central barrier rib located inside of the discharge cell is not less than the height of the lower discharge electrode, and a concave unit, into which the second extension unit is accommodated is formed on the other portion of the central barrier rib located outside of the discharge cell.

16. The plasma display panel of claim 1, wherein the lower discharge electrodes are extended in a direction to cross the extended direction of the upper discharge electrodes.

17. The plasma display panel of claim 1 further comprising address electrodes extended to cross the extended direction of the lower discharge electrodes and the upper discharge electrodes, and the upper discharge electrodes and the lower discharge electrodes are extended parallel to each other.

18. The plasma display panel of claim 17, wherein the address electrodes includes discharge units disposed in the central barrier ribs and horizontal connection units that connect the discharge units.

19. The plasma display panel of claim 18, wherein the height of the discharge unit is not less than the height of the lower discharge electrodes, the height of the horizontal connection units is lower than the height of the discharge units, and the discharge units and the horizontal connection units are connected by vertical connection unit in the central barrier ribs.

20. The plasma display panel of claim 18, wherein discharge units are disposed in the upper portion of the central barrier ribs.

21. The plasma display panel of claim 17, wherein the address electrodes are disposed on an upper surface of the lower substrate directly below the central barrier ribs, a dielectric layer is disposed between the address electrodes and the central barrier ribs, and the fluorescent layer is further formed on an upper surface of the dielectric layer.

22. The plasma display panel of claim 17, wherein the address electrodes includes two sub-address electrodes disposed on an upper surface of the lower substrate between the central barrier ribs and the lower barrier ribs, the address electrodes are covered by a dielectric layer, and the fluorescent layer is formed on the dielectric layer.

23. The plasma display panel of claim 22, wherein the two sub-address electrodes included in one address electrode are connected by a first connection unit.

24. The plasma display panel of claim 17, wherein the address electrodes includes two sub-address electrodes separated from the upper discharge electrodes and the lower discharge electrodes and disposed in the upper barrier ribs, and the fluorescent layer is further formed on an upper surface of the lower substrate.

25. The plasma display panel of claim 24, wherein the two sub-address electrodes included in one address electrode are connected by a second connection unit.

26. The plasma display panel of claim 17, wherein the address electrodes are disposed above the upper discharge electrodes and perform an address discharge together with the upper discharge electrodes.

27. The plasma display panel of claim 17, wherein the address electrodes are disposed below the lower discharge electrodes and perform an address discharge together with the lower discharge electrodes.

28. The plasma display panel of claim 1, wherein the lower barrier ribs are formed in the same pattern as the upper substrate.

29. The plasma display panel of claim 1, wherein the fluorescent layer is further formed on an upper surface of the lower substrate.

30. The plasma display panel of claim 1, wherein at least side surfaces of the upper barrier ribs are covered by a protection layer.

31. The plasma display panel of claim 1, wherein the upper barrier ribs and the lower barrier ribs are formed in one body.

32. A plasma display panel, comprising:
an upper substrate;
a lower substrate disposed parallel to the upper substrate;
a plurality of upper barrier ribs formed of a dielectric disposed between the upper substrate and the lower substrate, with the upper barrier ribs, the upper substrate and the lower substrate collectively defining a plurality of discharge cells;
a plurality of upper discharge electrodes disposed in the upper barrier ribs to surround the discharge cell;
a plurality of lower discharge electrodes separated from the upper discharge electrodes and disposed in the upper barrier ribs to surround the discharge cell;
a plurality of lower barrier ribs disposed between the upper barrier ribs and the lower substrate;
a fluorescent layer exhibiting a surface bearing a plurality of protrusions increasing a surface area disposed around the discharge cell; and
a discharge gas filling in the discharge cell.

33. The plasma display panel of claim 32 further comprising lower barrier ribs that define spaces for disposing the fluorescent layer and are disposed between the lower substrate and the upper barrier ribs.

34. The plasma display panel of claim 32, wherein the lower discharge electrodes are extended in a direction to cross the extended direction of the upper discharge electrodes.

35. The plasma display panel of claim 32 further comprising address electrodes extended to cross the extended direction of the lower discharge electrodes and the upper discharge electrodes, and the upper discharge electrodes and the lower discharge electrodes are extended parallel to each other.

36. The plasma display panel of claim 35, wherein the address electrodes are covered by a dielectric layer.

37. The plasma display panel of claim 35, wherein the address electrodes are disposed on the upper surface of the lower substrate.

38. The plasma display panel of claim 32, wherein at least side surfaces of the upper barrier ribs are covered by a protection layer.
